(19) United States
(12) Patent Application Publication
(10) Pub. No.: US 2024/0362919 A1
(43) Pub. Date: Oct. 31, 2024

(54) CAMERA BASED TRAFFIC MANAGEMENT FOR A TRAFFIC CIRCLE

(71) Applicants: Evelyn Shen, Palo Alto, CA (US); Crystal Jing Li, Palo Alto, CA (US)

(72) Inventors: Evelyn Shen, Palo Alto, CA (US); Crystal Jing Li, Palo Alto, CA (US)

(21) Appl. No.: 18/307,377

(22) Filed: Apr. 26, 2023

(51) Int. Cl. G06V 20/54; G06T 7/246; G06V 20/62

(52) U.S. Cl. CPC G06V 20/54; G06T 7/246; G06V 20/625; G06T 2207/10016; G06T 2207/20221; G06T 2207/30196; G06T 2207/30236

(57) ABSTRACT

Traffic circles are equipped with one or more cameras at its entrances of the traffic circles. The cameras, connected with sensors and central control units, determine speed and moving directions of vehicles entering or circling inside the traffic circle, based on artificial intelligence and machine learning. The speed of a vehicles can be determined by tracking a distance of the car to the camera and a distance between the camera lens and an image sensor inside the camera. The moving direction of the car can be determined by tracking the moving pattern of the car inside the traffic circle, among other ways. The central control determines the traffic pattern inside the traffic circle, gives signals like flashing lights, to vehicles entering the traffic circle to stop and yield to emergency vehicles, pedestrian crossing, or other vehicles approaching the entrance if the incoming vehicles do not have clearances to enter.

### TECHNICAL FIELD OF THE INVENTION

The described embodiments relate generally to traffic management methods in a traffic circle. More particularly, the described embodiments relate to using one or more cameras in the traffic circle to detect a speed and a direction of a vehicle moving inside the traffic circle; and signaling other vehicles about moving into the traffic circle; in order to reduce congestions and traffic accidents.

### BACKGROUND

A traffic circle, or roundabout, is a form of a circular intersection, as shown in FIG. 15A-15D, whereby vehicles move in a circular fashion, counterclockwise, around a center island to reduce severe crashes and increase capacity of the intersection.

Vehicles entering the traffic circle are required to yield to vehicles already circulating in the traffic circle. Before the traffic circle, traffic movement in an intersection or a crossroad was typically managed by traffic lights or signages such as stop signs. Traditional traffic lights are designed for heavy traffic in one or more directions to prioritize the traffic flow, large intersections, where space is constrained and not suitable for traffic circles, complexed intersections where drivers can be easily confused without traffic lights or views can be blocked by buildings nearby the intersections, or for intersections with frequent pedestrian and bicycle traffics. Drivers are required to obey the color of the traffic lights, i.e., proceeding into the intersection at a green light, clearing the intersection at a yellow light, and refraining from driving into the intersection at a red light. For side streets, simple intersections, or light traffic intersections, traffic lights may have more disadvantages than managing the traffic flow. A driver approaching a traffic light could sit behind a traffic light for minutes while the car is idling—wasting fuel and polluting the air. Accidents can be caused by drivers rushing through a yellow light or even a red light. A driver attempting to make a right turn, for example, may misjudge the speed of an incoming car and cause a collision. Traffic lights are not friendly for color blind people.

For simple intersections stop signs serve the same functions of directing traffic flows as traffic lights. A driver is to stop before entering the intersection and look for traffics in the other directions of the intersection before proceeding. During rush hours or one direction of the intersection having a heavy traffic flow, a driver behind multiple vehicles must stop and go multiple times before going through the intersection, which could be time consuming as well as fuel wasting. At a four way stop intersection, for example, the driver must decide which vehicle approached the intersection at first and often such determination is a pure guessing. Many drivers have habits not to fully stop behind the stop signs but to roll into the intersections. Drivers running through the stop signs could cause severe collisions.

Although requiring a large space to construct, a traffic circle offers high capacity and reduced accidents, compared to stop signs. A traffic circle can perform the same functions as stop signs without a driver stopping most of times. FIG. 15A to 15D show traffic patterns in and out of a traffic circle. Slightly different than going into an intersection with stop signs, a driver aiming to turn right, as shown in FIG. 15A, does not need to stop except if there is an approaching vehicle inside the traffic circle. The driver proceeds into the traffic circle, circulates about a quarter of the traffic circle before turning right to leave the traffic circle. Similarly, a driver going straight must circulate about half of the traffic circle before exiting, as shown in FIG. 15B. To perform a left turn at the intersection, a driver will first enter into the traffic circle, circulate about three quarters of the traffic circle, as shown in FIG. 15C, before exiting to the left. The traffic circle offers more one more advantage than a stop sign controlled intersection, as shown in FIG. 10D, that a driver can make a full circle within the traffic circle to make a U-turn at the intersection, which is difficult and often dangerous to do at other intersections with stop signs or traditional traffic lights. The performance all operations in a traffic circle does not require a stoppage of a vehicle and most importantly, every vehicle getting into or out of the traffic circle will move in the same direction, i.e., counter-clockwise, so that no traffic patterns will cross no matter how heavy the traffic is. Thus, traffic circles offer higher capacity and improved safety compared to traditional traffic lights or stop signs in terms of traffic flow management at intersections.

To be able to better manage the traffic flow in a traffic circle, a vehicle's speed and moving direction must be detected and tracked, both inside the traffic circle as well as any vehicles approaching the traffic circle. Traditional ways of determining a speed of a moving object may include a Doppler RADAR (Radio Detection and Ranging), in which a RADAR unit emits electromagnetic wave to hit a moving object. The electromagnetic wave is reflected by the moving object. The Doppler RADAR can determine a speed of the moving object, relying upon the scientific theory of “Doppler effect”, in which the frequency of the reflected magnetic wave shifts higher by an approaching object and lower by a moving away object. LiDAR, or Light Imaging Detection and Ranging, on the other hand, uses laser to target a moving object and measures the time for the laser to reflect back from the moving object to the LiDAR unit, in order to determine the speed of the moving object. LiDAR is also a form of time of flight (ToF) sensor. Although the present disclosure is not limited to any of the technologies, it is worth to point out that both RADAR and LiDAR have limitations in low visibility situations such as snowfall or rainfall, subject to reflectivity and scattering issues, and at higher costs. In addition, neither RADAR nor LiDAR can measure directions of a moving object other than approaching or moving away. In a traffic circle where a vehicle is free to turn either direction or even a U-Turn, tracking the direction of the moving vehicle is rather important for a better management of traffic flows in the traffic circle.

Despite these advantages, traffic circles often require large areas to construct. The higher the speed is allowed in the traffic circle, the higher the radius of the traffic circle. The center island is often planted with trees or other decorations, which also require higher maintenance costs. A driver's determination of the travel direction of a moving vehicle inside the traffic circle often requires a pure guess. For example, unlike in a traffic light or stop sign intersection that a left turn driver is required to turn on a left turn signal, in a traffic circle there is no such requirement since all vehicles are traveling in the direction, i.e., counter-clock-wise, inside the traffic circle. Thus, the driver will have no idea where a moving vehicle inside the traffic circle will go next, right turn, left turn, going straight, or even performing a U-turn. The trees or decorations on the center island can also block views of the driver in an approaching vehicle. If the driver enters the traffic circle without knowing how vehicles inside the traffic circle will move or which directions they are moving, a traffic collision could occur. In addition, since no vehicles are required to stop in the traffic circle, it can become hazardous for pedestrian crossing in any directions. This becomes more severe for more complexed traffic circle, with double lanes, or more than four entrances/exits. Therefore, there is a need to improve traffic managements in the traffic circle to reduce such risks, improve traffic flow and safety, as well as accommodate pedestrian crossing. There are traffic circles, however, implement lights, yield signs, or even stop signs in an attempt to resolve these issues but such methods are often counter-intuitive and causing more unforeseen problems.

### SUMMARY OF THE INVENTION

Embodiments of the systems, devices, and methods, described in the present disclosure are directed to methods of using synchronized cameras to control traffic flows in traffic circles. The traffic circles are equipped with cameras capable of taking pictures of incoming or exiting vehicles at high speed, at low light, and in severe weather situations. The cameras are at every entrance/exit of the traffic circle to monitor vehicle movements as well as pedestrians crossing a street. A picture of a vehicle is taken by one or more cameras in the vehicle's movement direction. The cameras are synchronized with each other by a central control, which is equipped with processing computers for calculation, decision-making and controlling of other equipment in the traffic circle besides the cameras. An object with known dimensions, such as a license plate, can be identified and used to track the vehicle movement inside the traffic circle. Subsequent pictures are taken by the same set of cameras and the data are used by the central control to calculate the speed and the moving direction of the vehicle. The central control will monitor which direction the vehicle will exit the traffic circle and how long it will take the vehicle to exit the traffic circle at the monitored speed. The methods of determination of the speed and moving direction of the vehicle inside the traffic circle will become clearer in the following descriptions. The traffic circle is also equipped with signals at every entrances. These signals may be a flashing stop sign, a lightning strip on the ground, or any other suitable devices to forewarn another driver who is about to enter the traffic circle to stop, yield, or avoid a traffic collision with the vehicle already in the traffic circle.

In one aspect, the present disclosure describes a method of determining the speed and direction of movement of a vehicle approaching the traffic circle using multiple cameras. A central control will set a priority to the vehicle into the traffic circle based on the timing the vehicle approaches one of the entrances of the traffic circle, and a comparison with movements of other vehicles inside or entering the traffic circle. Vehicles already inside the traffic circle always have higher priority and the vehicle approaching the traffic circle will be signaled to enter only if the movement paths of the other vehicles inside the traffic circle, based on their speeds and direction of movements, will not cross the path or will have sufficient time to avoid collision with the approaching vehicle.

In another aspect, the present disclosure describes a method of tracking a pedestrian crossing at the traffic circle. Pedestrians will be given the highest priority to cross, regardless of their speed or direction of movement. Vehicles approaching the traffic circle, which are determined not to have sufficient time to avoid crossing the path with the pedestrian's direction of movement will be signaled to stop at the entrances of the traffic circle. Vehicles already inside the traffic circle will be signaled to slow down to avoid crossing their paths with the pedestrian's direction of movement. The signaling will reset to the mode without pedestrian and control the movements of vehicles based on their speeds and directions of movement when the traffic circle is completely clear with the pedestrian. The same method can also be utilized to control movement of a biker inside the traffic circle.

In another aspect, the cameras combined with their processing control are capable of determining a speed of a moving vehicle. One or more cameras may take a first picture of a vehicle as the vehicle approaches the traffic circle. One or more known objects on the vehicle may be identified to compare a known database of these known objects, which may include a license plate, a brand logo of the vehicle manufacturer, etc. Pixels in an image sensor within the camera may flooded with photocurrents corresponding to the objects on the vehicle. The size of the objects may be determined by counting the area of pixels corresponding to the object. Subsequent pictures of the same objects may be taken by the same cameras. As the vehicle approaches the cameras, the size of the pictures increases, meaning more pixels of the image sensor are now corresponding to the same object. The camera will also record the focal point, the image distance, and maybe the object distance. As the vehicle moves away from the cameras, the size of the picture decreases, meaning less pixels of the image sensor are now corresponding to the same object. The central control, however, may be based on the Gaussian Equation, to set a different scaling factor so that the second picture will be at exactly the same size of the first one. To do so, a different focal point as well as a different image distance must be used as if the second picture is taken with a different zoom lens. By fitting the first focal point, first image distance, second focal point, and second image distance into the Gaussian Equation, a distance of the vehicle moving within the time interval between the camera taking the first and the second pictures may be determined. Thus, it is possible to determine the speed of the vehicle using one or more cameras equipped with image sensors.

In yet another aspect, each entrance of a traffic circle can be equipped with at least two cameras, which take a picture of a vehicle in the traffic circle simultaneously. The two cameras can take the picture of a known object on the vehicle. A centralized processing control can analyze the object to determine the moving direction of the vehicle inside the traffic circle. More specifically, the cameras are using the same image sensors with the same scaling factors such that the object on each image sensor should appear to be exactly the same size, that is, occupying the same area of pixels in each image sensor. When the object on the two pictures are the same, the vehicle is determined to move straight in the same direction of the two cameras, without turning. Whether the vehicle is moving away from the two cameras or approaching the two cameras can be determined based on the method described previously. When the vehicle is turning, for example, to exit the traffic circle to the right, as shown in FIG. 15A, the object would appear smaller in one picture from the first camera than that from the second camera, because of the longer distance between the first camera and the object. By comparing the sizes of the pictures on the same object from both cameras, the right turn of the vehicle can be determined, provided the angle, the focus, the scaling of the cameras are still kept the same when taking the subsequent shots. Of course, the traffic circle is round such that the vehicle would appear to change directions when rounding the traffic circle, this could be determined by fixing a threshold value of the two pictures such that when the comparison of the two pictures are over the threshold value the vehicle is determined to exit the traffic circle, not just rounding it. The cameras equipped on the opposite direction of the moving vehicle can also be utilized to determine the moving direction or the turning of the vehicle.

The image sensor may include a system-on-chip (SOC) to control the image sensor and the camera to process, enhance, compress image, and save output images to a flash drive. Based on real time image analysis, the SOC may provide control of the image sensor and the LEDs to adjust exposure time control, auto-gain control, and auto white balance; to adjust the image sensor frame rate or the operating mode. The SOC may also process zone average of an image and save a time-stamped image only if an image is different from a previous captured image. Machine learning algorithm may also be used to analyze captured images and to identify images with critical feature, such as incorporating time stamps on images.

The camera may include one high performance and high capacity flash drive to store all images. The content of flash drive may be transfer out to a control through a special designed USB cable or other special interfaces.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic of a traffic circle equipped with traffic cameras.

FIG. 2 shows a plan view of an image sensor and LED's.

FIG. 3 shows a typical block diagram of image sensor design.

FIG. 4 shows a typical schematic of an active pixel design.

FIG. 5 shows an example pixel readout in correlation to a size of an object.

FIG. 6 shows an exemplary vehicle license plate.

FIG. 7 shows an illustration of fundamental optical imaging system and imaging laws.

FIG. 8A-8D show relative position changes between the cameras and the tracked object moving in a circular fashion in the traffic circle.

FIG. 9A-9D show illustrations of the changes of the image size according to the movement of the tracked object.

FIG. 10A-10D are illustrations of pattern tracking of the vehicle by the cameras in the traffic circle.

FIG. 11A-11B are illustrations of a moving pattern of the vehicle rounding the traffic circle.

FIG. 12 shows cameras equipped in the center island of the traffic circle.

FIG. 13 is an illustration of traffic signals within the traffic circle.

FIG. 14 is a process flow diagram of decision making of the traffic circle management.

FIG. 15A-15D are schematic traffic circles and the moving patterns of a vehicle.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as may be included within the spirit and scope of the described embodiments as defined by the appended claim. References are made to by ways of examples and this is by no means limiting and a person with ordinary skills in the art may appreciate that a similar method in the invention may be used as well.

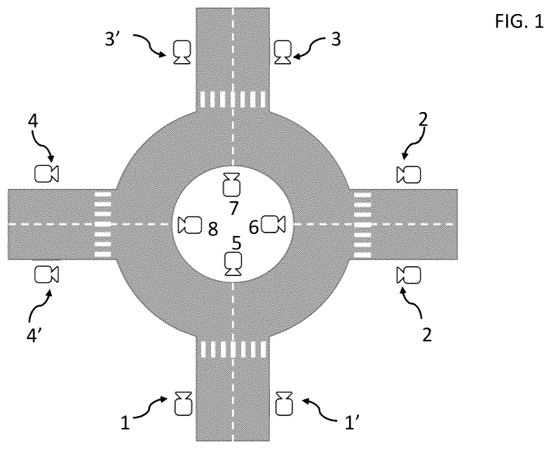

Reference is now made to FIG. 1, which illustrates a schematic of an exemplary traffic circle equipped with traffic cameras in each entrance of the traffic circle, according to one embodiment of the invention. Each entrance of the traffic circle may be equipped with two or more cameras 1-1′, 2-2′, 3-3′, 4-4′. The numbers as in FIG. 1 only indicate their associations with entrance, 1, 2, 3, and 4 in the exemplary traffic circle, and the “′” sign only indicates it is on the opposite side of the same entrance in the traffic circle, in comparison with the camera on the other side of the same entrance of the traffic circle. These cameras may be CCD or CMOS based with the capability of taking low light and low visibility shots at a high speed. The cameras may be installed on erected posts so that their views are not blocked by the vehicles, trees, or other objects in a center island of the traffic circle, as well as preventing vandalism. The cameras on the same entrance are installed such that they are not only symmetrical to each other as to an imagery center line dividing the road on the entrance, but also symmetrical to the other cameras on the opposite side of the traffic circle for a better precision of the measurement to be described below. Specifically and exemplarily, camera 1 is installed symmetrically as to camera 1′ in the same entrance, i.e. the camera 1 and the camera 1′ are installed such that they are of the same distance to the center line of the entrance, of the same height above the ground, and aiming at the same angle to a vehicle entering the entrance. The camera 1 is also symmetrical to camera 4 and the camera 1′ is symmetrical to camera 4′ on the opposite entrance of the traffic circle in terms of distances, heights, angles, etc., with respect to each other, as in the foregoing description.

Cameras 5, 6, 7, and 8 may also be installed on the center island of the traffic circle as an alternative or in combination with the outside cameras 1, 1′, 2, 2′, 3, 3′, 4, and 4′. The advantages of using one of these cameras on the center island will become clearer in the subsequent descriptions.

The image sensor in the camera may include a system-on-chip (SOC) to control the image sensor and the camera to process, enhance, compress image, and save output images to a flash drive. Based on real time image analysis, the SOC may provide control of the image sensor and the LEDs to adjust exposure time control, auto-gain control, and auto white balance; to adjust the image sensor frame rate or the operating mode. The SOC may also process zone average of an image and save a time-stamped image only if an image is different from a previous captured image. Machine learning algorithm may also be used to analyze captured images and to identify images with critical feature, such as incorporating time stamps on images. The cameras may include one or more high performance and high-capacity flash drive to store all images. The content of flash drive may be transfer out to a control through a special designed USB cable or other special interfaces. These cameras can be with a fixed zoom or an adjustable zoom to focus onto a specific area or object of a moving vehicle.

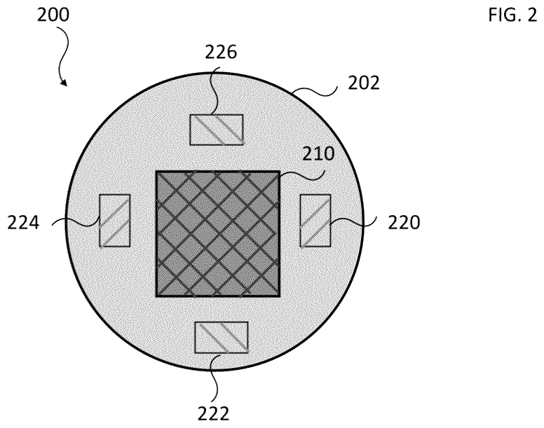

Reference is now made to FIG. 2, which illustrates a plan view of a typical imaging system 200 equipped in the traffic cameras 1-1′, 2-2′, 3-3′, 4-4′. An image sensor 210 is typically surrounded by LEDs 220, 222, 224, and 226 for low light or low visibility situations. The number of LED's may be any odd or even number to provide adequate illumination to the imaging system 200. The image sensor 210 is typically located at center of the imaging system 200 with the LEDs on a periphery of the image sensor 210. The image sensor 210 may be a charged-coupled device or more typically a backside illuminated image sensor made by CMOS technology. The LEDs support a pulsed operation mode which may be synchronized with an operation of the image sensor 210 to get optimal image quality with less power consumption.

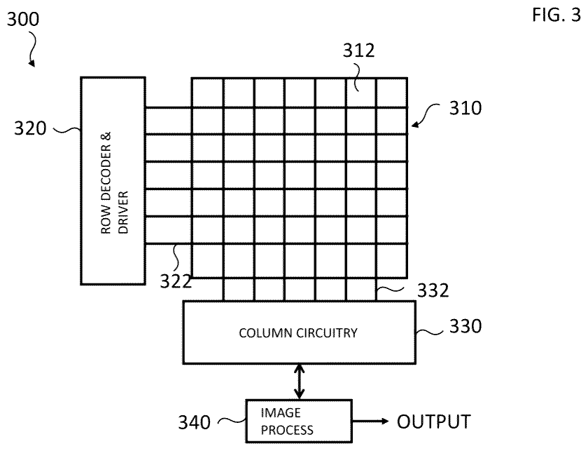

Reference is now made to FIG. 3, which shows a block diagram of an example of an image sensor 300, which may be used in the traffic cameras as described with reference to FIG. 1. The image sensor 300 may include an image processor 340 and an imaging area 310. The imaging area 310 may be implemented as a pixel array that includes a plurality of pixels 312. The pixels 312 may be the same colored pixels (e.g., for a monochromatic imaging area 310) or differently colored pixels (e.g., for a multi-color imaging area 310). In the illustrated embodiment, the pixels 312 are arranged in rows and columns.

The imaging area 310 may be in communication with a column select circuit 330 through one or more column select lines 332, and with a row select circuit 320 through one or more row select lines 322. The row select circuit 320 may selectively activate a particular pixel 312 or group of pixels, such as all the pixels 312 in a certain row. The column select circuit 330 may selectively receive the data output from a selected pixel 312 or group of pixels 312 (e.g., all of the pixels in a particular row). The row select circuit 320 and/or column select circuit 330 may be in communication with the image processor 340, which may process data from the pixels 312 and output that data to another processor, such as a system on a chip (SOC) included in on a printed circuit board.

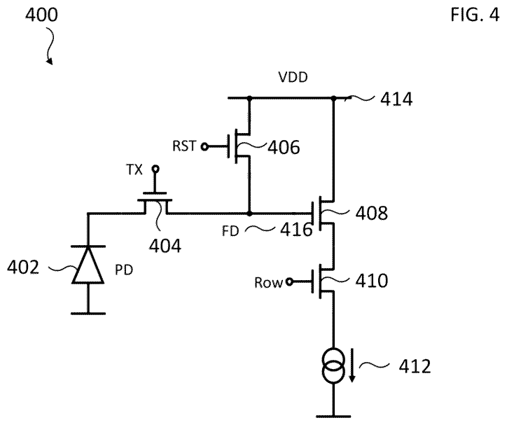

FIG. 4 shows an exemplary schematic design of an active pixel 400. A photodetector 402 is used to convert the photo generated electron-hole (e-h) pairs into a photocurrent. A common photodetector 402 used in a CMOS image sensor, such as the image sensor shown in FIG. 3, is a PIN photodiode, where a built-in p-n junction between a p-doped region and an n-doped region provides an electric field for the collection of generated charges by the photodetector. The actual number of e-h pairs generated by incident photons are measured by a quantum efficiency (QE) defined as the ratio of the photocurrent generated by the photodetector 402 to the photon flux incident on the photodetector 402. Quantum efficiency (QE) is one of the most critical parameters in pixel designs in a CMOS image sensor.

Besides the photodetector 402, the pixel 400 also comprises four transistors (4T) that include a transfer gate (TX) 404, a reset transistor (RST) 406, a source follower (SF) amplifier 408, and a row-select (Row) transistor 410. The transfer gate 404 separates the floating diffusion (FD) node 416 from the photodiode node 402, which makes the correlated double sampling (CDS) readout possible, and thus lowers noise.

The signal-to-noise-ratio (SNR) and dynamic range (DR) are very important figures of merit for image sensors. The dynamic range quantifies the sensor's ability to adequately image both high light and low light scenes. For traffic circle camera control system, it is important to choose sensors with extended dynamic range both at low light illumination and high light illuminations. Normally more than 120 dB sensor dynamic range is required to capture high quality images for both day and night conditions.

To improve image quality at low light, a readout noise from the image sensor must be reduced as much as possible. Correlated double sampling readout may remove kTC noise from RST gate 406 and reduce the readout noise by at least an order of magnitude. A low noise circuit design is also required for the pixel source follower amplifier 408, the pixel bias circuit 412, and a column amplifier and comparator circuitry of analog to digital converters (ADC).

Several techniques and architectures have been proposed for extending image sensor dynamic range at high light illumination conditions, such as multiple exposure approach, etc. The idea is to capture several images at different exposure time—shorter exposure time images capture the bright areas of the scene while longer exposure time images capture the darker area of the scene A high dynamic range image is then synthesized from the multiple captures by appropriately scaling each pixel's last sample before saturation. Multiple exposure approach involves several captures at different time, which results in quite complicated camera system.

Single exposure high dynamic range sensor design is preferred for traffic circle control system. Split photodiode design is one of best approach to achieve single exposure wide dynamic range design. Split photodiode design separates each pixel into one large photodiode and one small photo diode. The large photodiode can provide high Quantum Efficient and excellent low light image quality, the small photodiode features lower quantum efficiency and large full well capacity, thus extend sensor dynamic range in high light. The exposure time can be synchronized between large photodiode and smaller photodiode. A single exposure high dynamic range image can be synthesized from both large photodiode and small photodiode captures by appropriately scaling each pixel's last sample before saturation. The single exposure high dynamic range sensor is optimal design option for traffic circle control system.

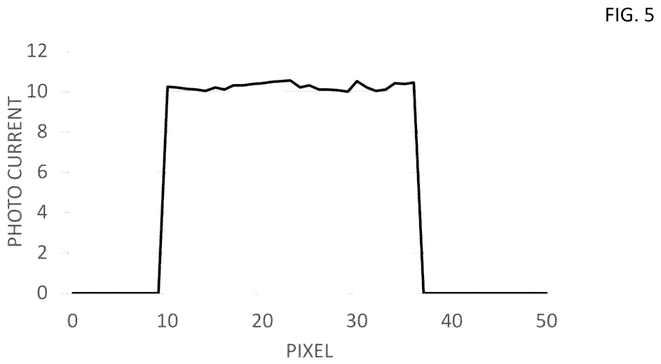

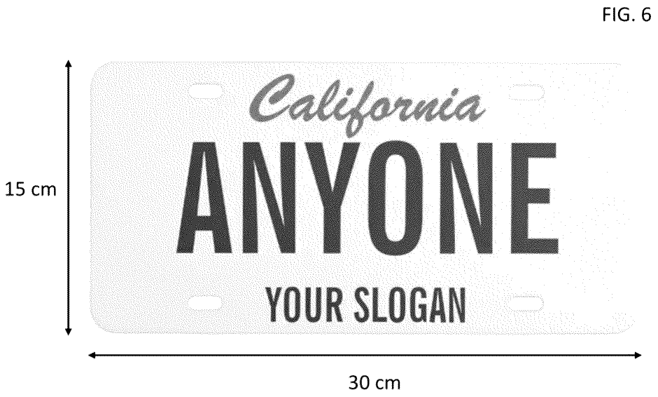

Reference is now made to FIG. 5, which is an illustration of a photocurrent generation in the pixels such as in pixels 400 shown in FIG. 4. For the illustration purpose, FIG. 5 only shows the photocurrent generation in a row of pixels in correlation to an object, e.g., a vehicle, captured by the exemplary image sensor 300. As shown in FIG. 3, the image sensor 300 typically consists of plurality of rows and columns of similar pixels, typically in the number of hundreds or thousands. Photons reflected from the object flooded the photo detectors 402 in the image sensor 300. The photo detectors 402 in turn generate photocurrents, which as shown in FIG. 5 as having certain values above the noise level. The photocurrent is at the noise level in the image sensor area where the photo detectors 402 do not receive photons reflected from the object, such as in the pixels 1-10 or beyond 36, as shown in FIG. 5. This example illustrates only one row or one columns of pixels 400 and how the photocurrents are generated by the photo detectors 402 in such a row or column of pixels in correspondence to the object. It can be appreciated that an image area of the object can be obtained by counting the rows and columns of the pixels activated by the photons from the object on the image sensor 300. To further illustrate, reference is made now to FIG. 6, which shows an exemplary license plate issued by California State Department of Motor Vehicles. These license plates, although different in color and design, having different styles, letters or numbers, are most likely made of metal and of the same dimensions of 30×15 cm, as shown in FIG. 6. The dimension of this object can be stored in the image sensor 300 for comparison with the image area on the image sensor 300 for the detection of a speed and a moving direction of the vehicle, which will become clearer in subsequent descriptions. Other regions or countries where license plates are of different sizes. In European Unition region for example, a license plate is 52×30 cm, so that it at least appears that these different dimensions must be stored in the image sensor 300 if the traffic cameras are equipped in different regions or countries.

It can be appreciated that the license plate used here is only by a way of example to identify and track a vehicle. Other methods may be used to identify and track a vehicle. For example, a camera equipped with an image sensor and a microprocessor unit may take a picture of a vehicle, use artificial intelligence to identify the year, model, and manufacturer of the vehicle. The dimensions of the vehicle are pre-stored in the camera for comparison with subsequent pictures taken to detect a speed and moving direction of the vehicle, which will become clearer in further descriptions.

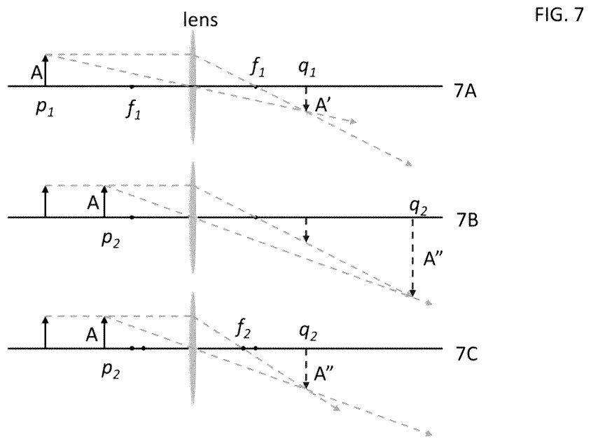

Reference is now made with respect to FIG. 7, which is a simplified illustration of fundamental optical imaging system and imaging laws, in which, the photons reflected by the object, such as the license plate as contemplated in FIG. 6, go through the lens in front of the camera to reach the image sensor 300 as in FIG. 3 to form an image of that object. In FIG. 7, the lens is for illustration purposes only and in reality a sophisticated camera often have many lenses in front of the image sensor 300 and the imaging system is very complexed. This is not necessary, however, for the description herein. As shown in 7A, an object approaching the traffic camera near the traffic circle as shown in FIG. 1 (i.e., the lens) would form an inverted image on the sensor 300. If A is the size of the object, the actual size of the image on the sensor 300 is A′, depending on the distance p₁ between the object and the lens, the focus length f of the lens, and the distance q₁ between the image and the lens. The basic imaging law dictates the relation:

$$\frac{1}{p 1} + \frac{1}{q 1} = \frac{1}{f 1} \qquad ( 1 )$$

When the object, e.g. a vehicle, approaches the camera, as shown in 7B, its distance p₂ is closer to the lens than that of p₁, and now the image distance q₂ is longer than that of q₁, but the focus length of the lens has not changed, and the image formed on the image sensor 300, A″, would appear to larger than A′. The equation (1) still satisfies as:

$$\frac{1}{p 2} + \frac{1}{q 2} = \frac{1}{f 2} \qquad ( 2 )$$

From 7A-7C, it can be appreciated that at least the following equations are satisfied.

$$\begin{matrix}p 1 = \frac{A}{A ′} \times q 1 & ( 3 ) \\ p 2 = \frac{A}{{A}^{″}} \times q 2 & ( 4 )\end{matrix}$$

From the preceding descriptions associated from FIG. 5, it can be appreciated that the actual size of the object, A, is pre-stored in the image sensor processing unit for comparison. The actual size of the images, A′ and A″, can be ascertained with from counting the pixels actually activated by this the object, e.g., a vehicle. In a camera configuration, the image sensor 300 is at a fixed position with respect to the camera lens, i.e., q₁=q₂. Therefore, the values of p₁ and p₂. as well as the difference between them (p₁−p₂), can be calculated by the processing unit. The time interval between the two images taken, t, is known to the camera and the processing unit. Therefore, the moving speed, s, of the object, e.g., the vehicle, can be calculated as:

$$s = \frac{p 1 - p 2}{t} \qquad ( 5 )$$

For a vehicle (object) moving away from the camera, the image on the image sensor 300 would appear smaller but the speed s can be calculated the same way by taking the absolute value of the calculation, regardless of the moving direction of the vehicle. It can be appreciated that the speed can be calculated by taking multiple pictures during the moving of the vehicle at a certain time interval. If a video camera is used, continuous frames can be taken of the same object with a known frame rate so that any two frames can be used to calculate the speed of the moving object.

An alternative way is to determine the distance p₂ is to find a pair of q₂ and f₂ and feed them into the Equation (2) to determine p₂, according to the image size A″. The image size increases when the object approaches the camera and decreases when the object moves away from the camera. The actual size of the object, e.g., the license plate, and the image size at various distances from the camera, as shown in 7B, may be pre-stored in the camera as well so that once the image size is determined according to the description disclosed herein, the distance of the object from the camera may be ascertained. Yet another alternative is to use sensing devices, for example, a sensing device at the entrance of the traffic circle as shown in FIG. 1, to trigger the camera so that distance p₁ is known before recording the speed of the vehicle entering or leaving the traffic circle. Such a sensing device may be a pressure sensor buried underground so that a vehicle on top of it will create a pressure difference to trigger the traffic cameras. Such a sensing device may also be a light sensor across the entrance of the traffic circle and a passing vehicle will block the light to trigger the cameras. Other devices to sense a vehicle and trigger the traffic cameras will be known to a person having ordinary skills in the art. To the same extent, such sensing devices may also provide a signal to stop the cameras from taking images or videos and from tracking the same vehicle when the vehicle leaves the traffic circle.

By taking multiple pictures of the vehicle, or a continuous video with known frame rate, the speed of the moving vehicle at different times may be ascertained. It may be appreciated that the vehicle may accelerate or decelerate in or near the traffic circle so that by tracking the speed of the vehicle continuously the acceleration or deceleration of the vehicle may also be determined.

The moving vehicle in the traffic circle, according to the setting shown in FIG. 1, will be tracked by one or more cameras at the same entrance, and/or one or more cameras at the opposite entrance. The speed calculated by the one or more cameras at the same entrance can be compared to the speed calculated by the one or more cameras at the opposite entrance. As described previously, the speed should be the same, regardless whether the vehicle is approaching the entrance or moving away from the entrance. Multiple camera settings will also provide another way to track multiple vehicles inside or outside the traffic circle at the same time.

The vehicle speed described heretofore is called linear speed. Considering the traffic circle is circular in shape and the vehicle travels along the circle, it is more important to ascertain the angular velocity, or angular speed so that the traffic management system, e.g., the traffic cameras, the central controls, etc., would know the exact location of the vehicle within the traffic circle, and predict the movement of the vehicle according to its speed. The angular speed can be calculated as:

$$ω = \frac{S}{r} \qquad ( 6 )$$

where ω is the angular speed of the vehicle and r is the radius of the traffic circle. With the angular speed of the vehicle is known, it is feasible for the central control to predict the movement of the vehicle in the traffic circle.

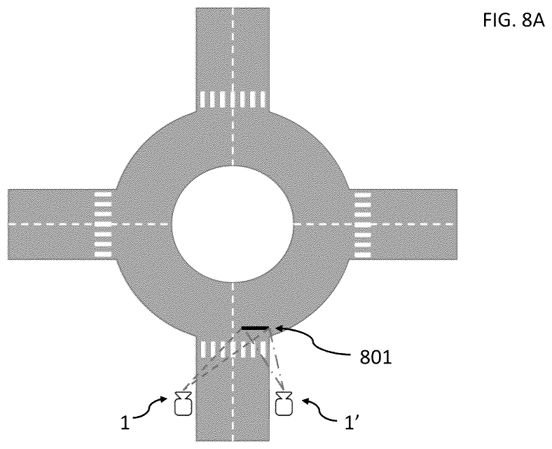

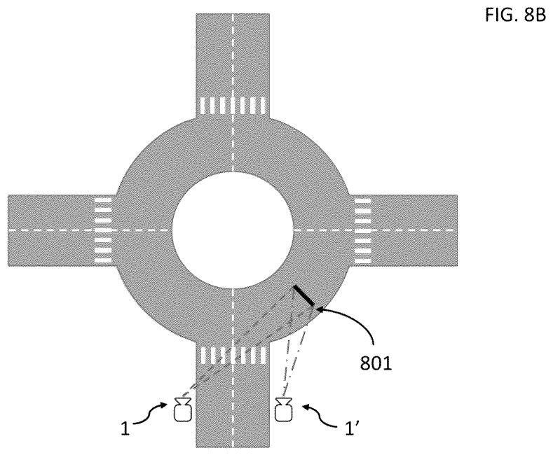

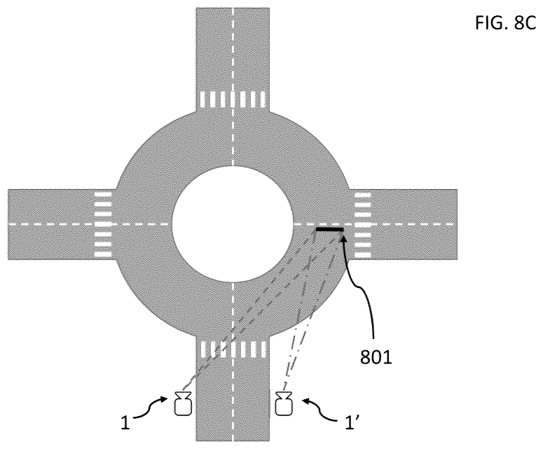

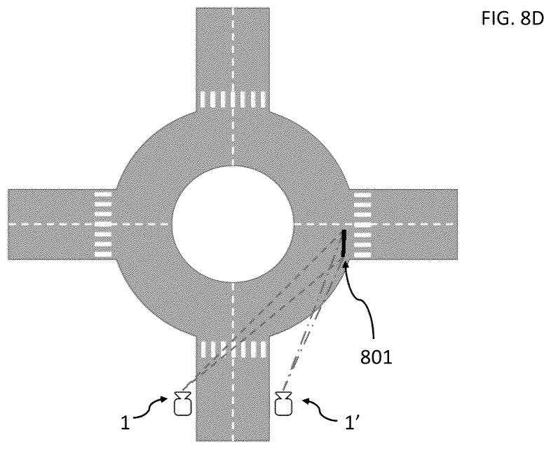

Now reference is made to FIG. 8A-8D, which illustrate how the cameras combined with the central control can detect the movement direction of the vehicle. For simplification reasons only camera 1 and 1′ are labeled in the traffic circle and the object tracked by the cameras, e.g., a license plate of the vehicle, is labeled 801 without showing the actual vehicle. These cameras are installed so that their initial focus points are towards to the center of the traffic circle. As shown from FIG. 8A-8C, where FIG. 8A represents the vehicle just or about to enter the traffic circle, FIG. 8B represents the vehicle moves about halfway between its entrance and the next entrance, and FIG. 8C represents the vehicle moves just or about the next entrance. Looking at the representative license plate 801 tracked by the cameras 1 and 1′, a person having ordinary skills in the art can appreciate that as the vehicle moves around the traffic circle, the angles of the license plate 801 facing the cameras 1 and 1′ are changing constantly. The image of the license plate 801 formed on the image sensor in the camera 1 will change, thus, at an initial size A1 in the position shown in FIG. 8A, when the vehicle is about or just enter the traffic circle. Similarly, the image size on the image sensor in the camera 1′ will be also at an initial size A1′. The ratio of A1/A1′ can be ascertained by the central control. In the position shown in the FIG. 8B, this ratio is represented as B1/B1′. At the position shown in the FIG. 8C, this ratio is represented as C1/C1′. Although for illustration purposes there are only three positions shown in the FIG. 8A-8C, in reality the high-speed cameras 1 and 1′ can take many pictures or continuous videos to track the movement direction of the vehicle and the ratio of the image sizes between camera 1 and 1′ can be automatically calculated and tracked. At various different locations inside the traffic circle, the size of the image of the tracked object formed on the image sensors of the cameras 1 or 1′ changes according to the relative angle to the cameras 1 or 1′. Wide angle cameras can be used so that the purviews of the cameras can encompass the entire traffic circle or at least an entire quadrant of the traffic circle. The ratio of the image sizes of the two cameras varies within a range while the vehicle moves about the traffic circle within the quadrant. If the vehicle is turning a 90-degree direction, i.e., exiting the traffic circle, as illustrated in FIG. 8D, the ratio of the image sizes exceeds this range. By storing the range data into the central control and comparing the actual ratio of the images taken at real time with this range, the central control can determine the vehicle is exiting the traffic circle in the next exit.

It may be appreciated that while the vehicle is moving about the traffic circle and moving away from the cameras 1 and 1′, the object distance changes, as shown in FIG. 7, along with the image sizes. The cameras are capable of adjusting a scaling factor, or zoom, to adjust the image size and to eliminate this factor while comparing the ratio of the image sizes between the two cameras.

It may also be appreciated that once the ratio does not exceed the range and the central control determines that the vehicle continues to move about the traffic circle without exiting, the tracking can be handed off to the cameras in the adjacent pairs to continue the tracking in order to avoid some blocking of the purviews of the cameras 1 and 1′ by the center island of the traffic circle when the vehicle moves more than a quadrant of the traffic circle from original entrances position.

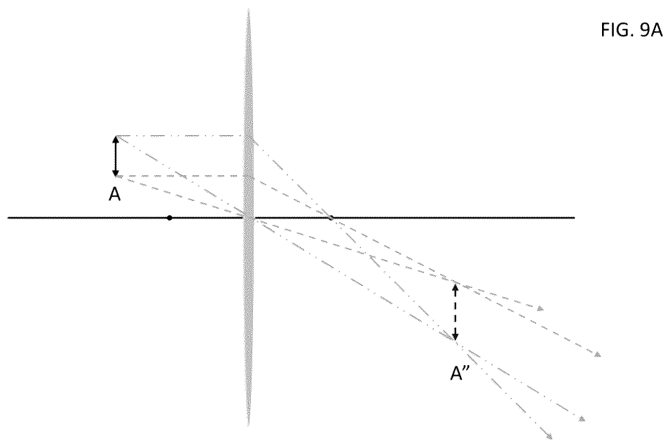

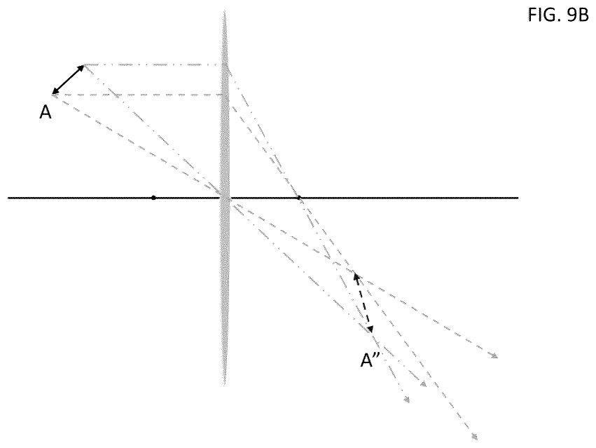

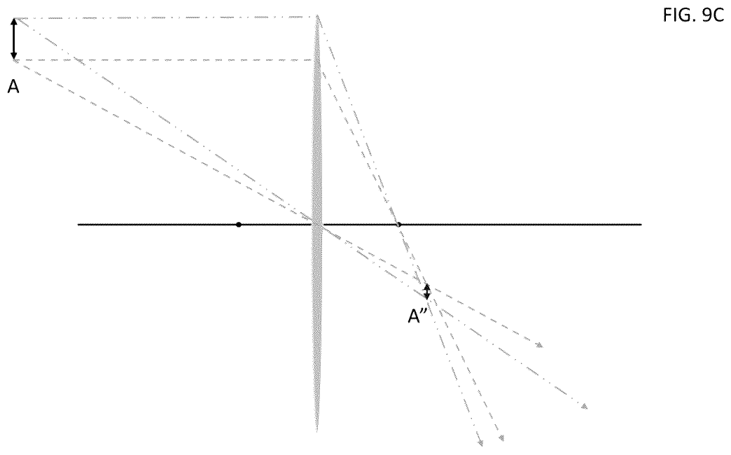

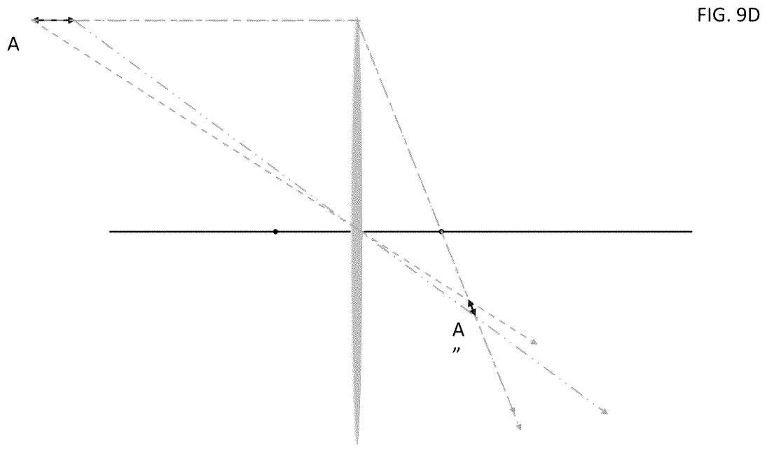

Now reference is made to FIG. 9A-9D, which further illustrate the change of the image size of the tracked object according to the movement direction of the vehicle moving in the traffic circle. FIG. 9A-9C illustrate the image formed on the image sensor of at least the camera 1, as the vehicle moving at its first entrance position, the middle of the quadrant of the traffic circle, and at the next exit. Without adjusting the scaling or zoom factor, the image size and its position vary. On the pairing camera 1′ the size and position of the image change accordingly. The ratio of the image sizes between the camera 1 and the pairing camera 1′, varies within a range. When this ratio exceeds the pre-stored values, the central control predicts and determines that the vehicle is leaving traffic circle by exiting to the right.

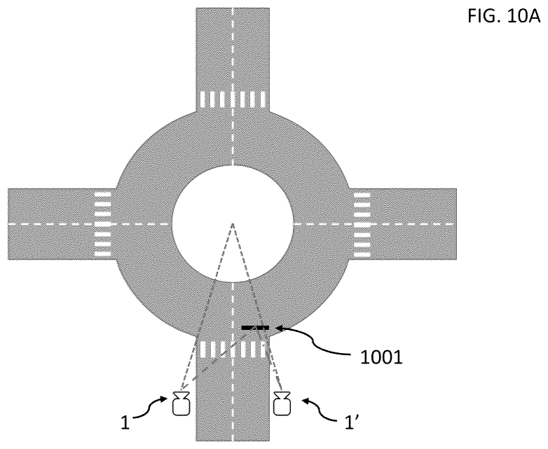

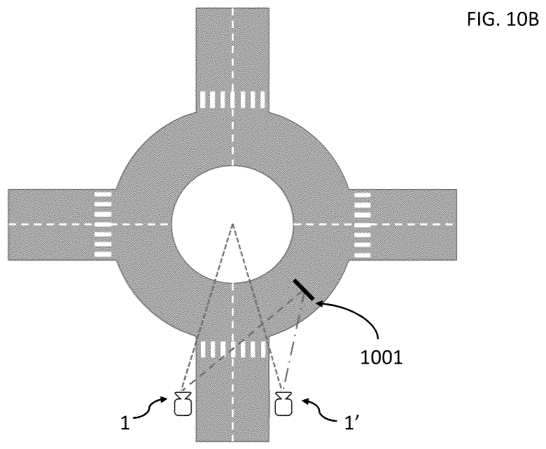

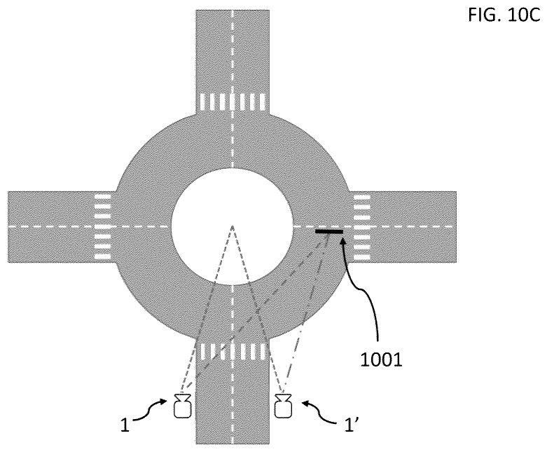

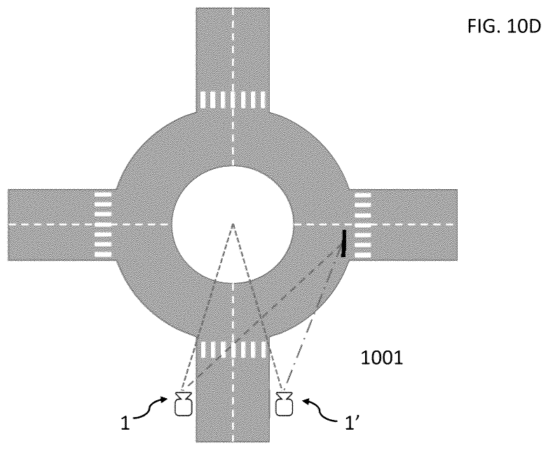

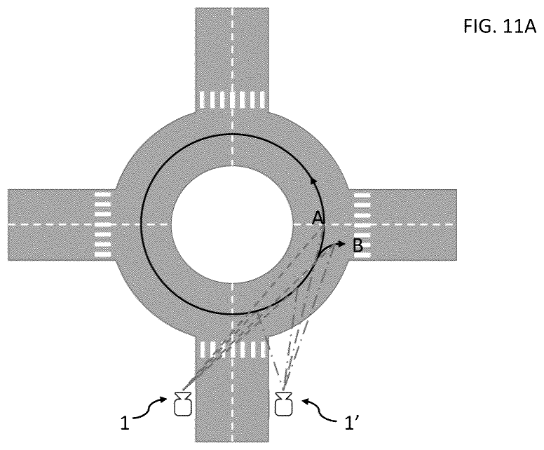

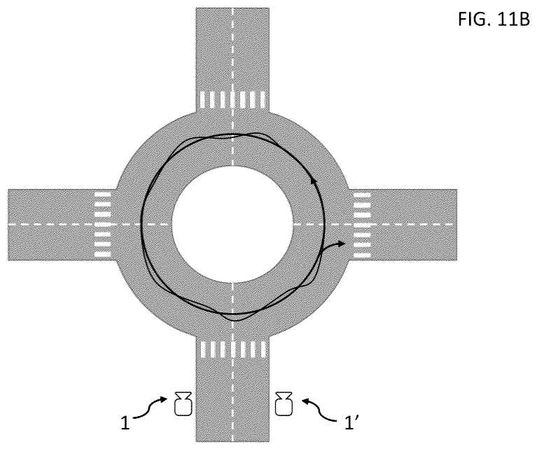

New reference is made to FIG. 10A-10D, which illustrate another way to detect and predict the movement direction of the vehicle in the traffic circle. FIG. 10A-10D illustrate the tracked object, e.g., the license plate of the moving vehicle by the cameras 1 and 1′ in the traffic circle. The vehicle moves away from its initial position entering the traffic circle, the cameras 1 and 1′ can at least detect its speed, the angular speed, and the distance from its initial position, as described previously. The cameras 1 and 1′ have their fixed angles and distances to the center of the traffic circle, as shown in the FIG. 10A-10C. Thus, it may be appreciated that a presumed pattern of the vehicle, or the tracked object, will move in a circular fashion, while the vehicle moves about the traffic circle. This can be further illustrated in FIG. 11A, in which the presumed pattern of the moving object is shown as a solid inner circle. Once the angular speed of the moving object is determined, the central control can at least predict the next position of the moving object in the inner circle if the vehicle keeps rounding the traffic circle. It may also be appreciated that the traffic circle or traffic lanes are wider than a vehicle so that the moving pattern of the vehicle is often not in a perfect circle but in a random fashion around the perfect circle, as shown in FIG. 11B. This can be corrected by the central control. The cameras 1 and 1′ detect the positions or the distances from either one or both cameras, as d₁, d₂, d₃, d₄, etc. and such data are fed into the central control, which takes a moving average as follows:

$$moving average = \frac{sum ( d 1 , d 2 , d 3 , … dn )}{n} \qquad ( 7 )$$

The more data used to calculate the moving average, the more accurate the central control can predict the traffic pattern.

Based on the moving pattern model, the angular speed, and the speed of the vehicle, the central control can predict the next position A the vehicle would be in a given time. The predicted moving pattern may not be a perfect circle but an oval or other shapes. A certain degree of errors or deviations within a threshold value from a perfect circle must be permitted when predicting the vehicle moving pattern.

As shown in FIG. 10D, when the vehicle is exiting in, for example, the adjacent exit of the traffic circle, the moving pattern of the vehicle deviates from the predicted pattern exceeds the threshold value. As indicated by position B in the FIG. 11B, the vehicle is turning right and moving away from the predicted pattern. When the deviation from the predicted moving pattern is greater than the threshold value, the centra processing control will determine the vehicle would not continue rounding the traffic circle but exit the traffic circle at position B, where it moving direction deviates from the predicted moving pattern.

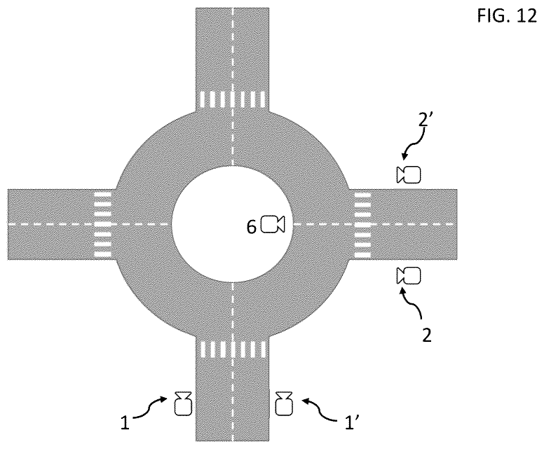

It is worth noting that the tracking of the vehicle may be carried out by not only cameras 1 and 1′ but with combination of other cameras on the center island of the traffic circle, as shown in FIG. 12, where only the camera 6 is shown to help detecting the moving direction and predicting when the vehicle leaves the traffic circle. In the position, from the vehicle entering the traffic circle till it moves about the first quadrant of the traffic circle to the right, the tracked object, e.g., the license plate, is not within the purview of the camera 6. When the vehicle is turning right at the first exit to leave the traffic circle, its moving direction is changing significantly comparing to normal zigzagging, wobbly, or deviation from the perfect circle pattern as described in previous sessions. As a result, its license plate tracked by the cameras 1 and 1′ would be detected by the camera 6 the first time during the movement of the vehicle inside the traffic circle. The central control will, based on this first detection or subsequent pluralities of detections, e.g., images taken by the camera 6, determine the exiting pattern of the vehicle.

The other exits obviously are monitored by the rest of inner circle cameras 5, 7, and 8, and their data can be used to determine the exiting location of the vehicle in the traffic circle.

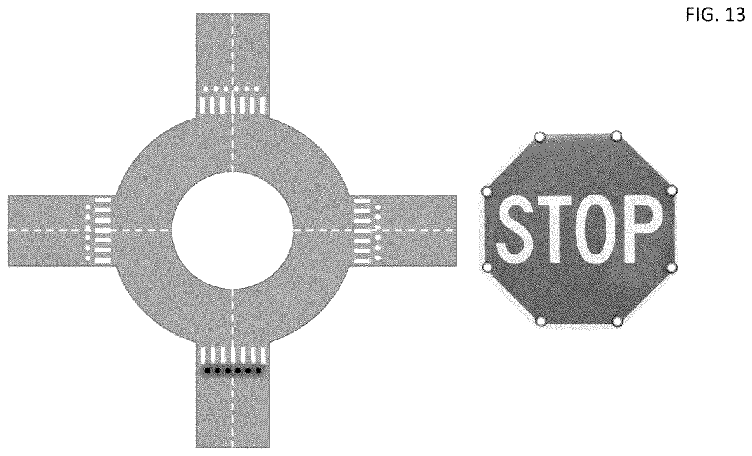

Reference is now made to FIG. 13, which illustrates how the central control will signal vehicles about to enter the traffic flow. There are multiple ways the central control can signal incoming cars. The illustrations in FIG. 13 are by ways of examples not limitations. LED lights can be installed on the ground at the entrance of the traffic circle and can be turned on in a flash mode when the central control determines, based on the traffic pattern inside the traffic circle, that the incoming car does not have enough clearance from other cars or pedestrians. The driver of the car must stop behind the flashing LED lights and wait until the lights are off before entering the traffic circle. When the LED lights are off, the driver can drive into the traffic circle without stopping, although precaution is still necessary, and the driver may still have to look around the traffic circle to make sure it is completely safe to enter. The signaling, however, will lessen the burden on and judgmental errors by the driver when making decisions when to enter the traffic circle. The color of the LED lights can be red or yellow for better visibility in a low light condition. The LED lights can be turned on by remote sensors connected to the central control by Bluetooth or WiFi, or simply wired to the central control. Another way is to use stop signs with lights, as shown in FIG. 13. These lights in the stop sign or even a yield sign can perform the same way as the LED lights and may be easier to see since they are above the ground. Signal lights can also be installed in the center island of the traffic circle if spaces are tight at the entrances of the traffic circle.

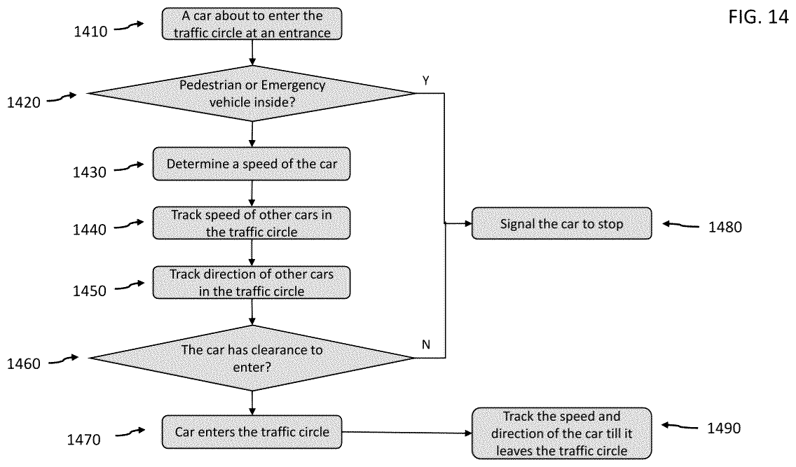

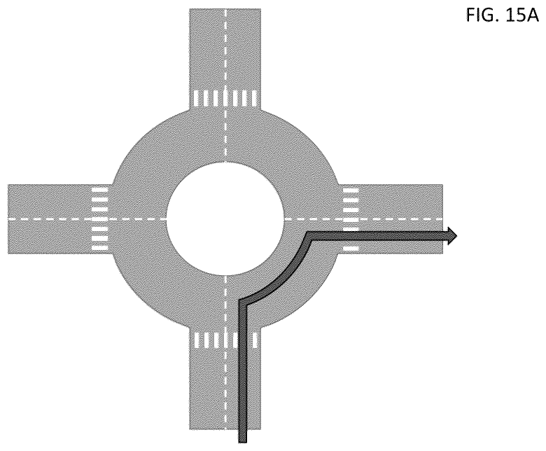

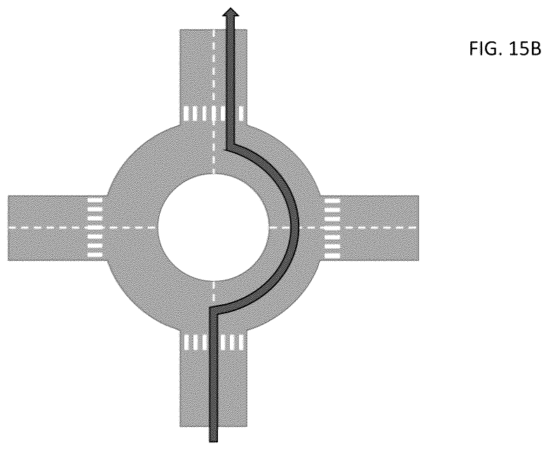

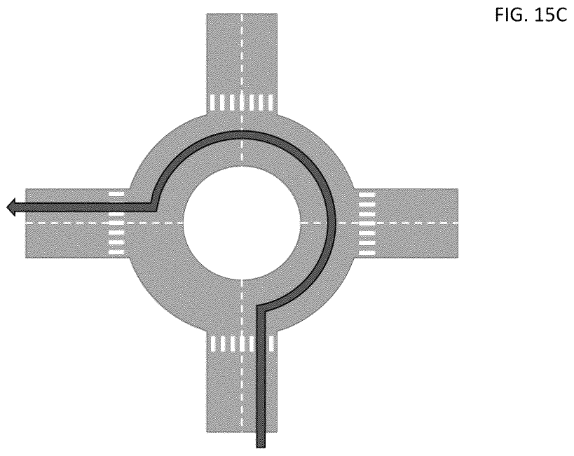

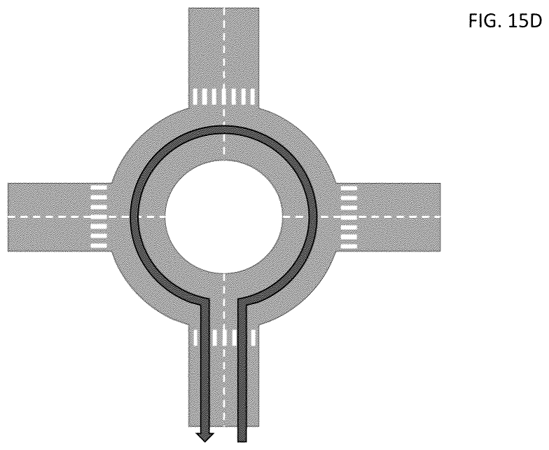

Reference is now made to FIG. 14, where a decision-making process by the central control is illustrated. In step 1410, one or more traffic cameras installed in the traffic circle detects a vehicle about to enter the traffic circle. The central control determines whether there are pedestrians crossing at the same entrance or whether there are emergency vehicles inside or approaching the traffic circle, in step 1420. Pedestrians and emergency vehicles always take higher priorities than the vehicles. If there are pedestrians crossing at the same entrance, for example, or an emergency vehicle inside or approaching the traffic circle, the central control will automatically signal the vehicle about to enter the traffic circle to stop, in step 1480. Or, in the emergency vehicle situation, the central control will signal all vehicles about to enter the traffic circle to stop and yield to the emergency vehicle. In step 1430, the central control, relying upon the cameras, determines the speed of the incoming vehicle, based on the described elsewhere in this disclosure. Since the central control has already been tracking the speed of the vehicles, in step 1440, and directions of the vehicles, in step 1450, inside the traffic circle, the central control will calculate and determine whether the incoming vehicle has clearance to enter the traffic circle, based on its speed and the speed and directions of the vehicles approaching that entrance. If the central control determines that the incoming vehicle does not have the clearance, for example, another vehicle will cross its path at the entrance based their perspective speeds and moving directions, the central control will signal the incoming vehicle to stop outside the traffic circle, till the passage of the other vehicle or vehicles. If the incoming vehicle does have the clearance, no signal is given and the car enters the traffic circle, after which the central control will track its moving speed and moving directions until it leaves the traffic circle, in step 1490. Once the car is inside the traffic circle, it will be treated just as other cars inside the traffic circle as in steps 1440 and 1450 for overall traffic management of the traffic circle.

What is claimed is:

1. A method of detecting a speed of a moving object, comprising:
providing a camera equipped with an image sensor having a plurality of pixels;
identifying the moving object approaching or leaving a traffic circle;
taking a first image of the moving object with the camera;
taking a second image of the moving object with the camera;
recording a time interval of between the first and second images;
tagging at least a portion of the moving object in the first image, the portion having a pre-determined size;
tagging the portion of the moving object in the second image;
determining a first area of pixels occupied by the portion in the first image;
determining a second area of pixels occupied by the portion in the second image; and
determining the speed of the moving object.

2. The method in claim 1, wherein the moving object is a car and the portion of the moving object is a license plate of the car.

3. The method in claim 2, wherein determining the first or area of pixels in the first or second image, respectively, is by counting the number of pixels occupied by the portion.

4. The method in claim 3, further comprising stitching images of two or more cameras from the same direction.

5. The method in claim 1, further comprising superimposing the first area and the second area so that centers of the first area and the second area are aligned.

6. The method in claim 4, wherein the determining the first or the second area of pixels in the first or second image, respectively, is by counting the number of pixels having substantially higher photo currents with respect to the portion than other portions of the car.

7. The method in claim 1, further comprising setting a scaling factor of the camera whereby the portion occupies a substantial number of pixels in the taking of the second image.

8. The method in claim 7, further comprising adjusting the first image utilizing the scaling factor of the camera.

9. The method in claim 1, wherein the speed of the moving object is determined by taking a continuous video from the camera having a constant frame rate.

10. A method of detecting a direction of a moving object, comprising:
providing a plurality of cameras with identical image sensors having identical number of pixels and size of pixels;
identifying the moving object approaching or leaving a traffic circle;
taking a first image of the moving object with a first camera from the plurality of cameras;
taking a second image of the moving object with a second camera from the plurality of the cameras synchronized with the first camera;
tagging at least a portion of the moving object in the first image, the portion having a pre-determined size;
tagging the portion of the moving object in the second image;
determining a first area of pixels occupied by the portion in the first image;
determining a second area of pixels occupied by the box in the second image; and
determining the direction of the moving object.

11. The method in claim 10, wherein the moving object is a car.

12. The method in claim 11, wherein the portion is a license plate of the car.

13. The method in claim 10, further comprising comparing the first area of pixels occupied by the portion with the pre-determined size and calculating a first angle of the moving object to the first camera.

14. The method in claim 13, further comprising comparing the second area of the pixels occupied by the portion with the pre-determine size and calculating a second angle of the moving object to the second camera.

15. A method of traffic management in a traffic circle, comprising:
providing a plurality of cameras in an entrance of a traffic circle;
determining a speed and a direction of a car into the traffic circle;
predicting a clearance of the car with other cars about entering the traffic circle;
signaling the other cars to stop outside the traffic circle if the clearance is below a threshold; and
tracking the car exiting the traffic circle.

16. The method in claim 15, further comprising tracking a movement of a pedestrian entering or exiting the traffic circle.

17. The method in claim 15, wherein the plurality of cameras include CMOS image sensors having identical sizes.

18. The method in claim 15, further comprising setting a baseline area in the traffic circle and tracking multiple cars entering or exiting the roundabout to determine a traffic pattern inside the baseline area.

19. The method in claim 15, wherein the signaling comprises a lighting on a ground near an entrance of the traffic circle or on an erected sign, signaling the other cars before they enter the traffic circle.

20. The method in claim 15, wherein the determining of the speed of the car is based on the method in claim 2.

21. The method in claim 15, wherein the determining of the direction of the car is based on the method in claim 10.
